(19) United States
(12) Patent Application Publication
(10) Pub. No.: US 2002/0197132 A1
(43) Pub. Date: Dec. 26, 2002

(54) High strength spray metal tubular coupling

(76) Inventors: Arturo De La Cruz, Greenville, TX (US); James Fraysur, Sharon, OK (US)

Correspondence Address: WILLIAM B. PATTERSON, MOSER, PATTERSON &Sheridan, L.L.P., Suite 1500, 3040 Post Oak Boulevard, Houston, TX, 77056, US

(21) Appl. No.: 09/888,071

(22) Filed: Jun. 22, 2001

(51) Int. Cl. C21D 1/00; F16B 37/00

(52) U.S. Cl. 411/427; 148/519; 148/537

(57) ABSTRACT

A high strength sucker rod coupling for use with high strength sucker rods, and methods for fabricating the coupling. The coupling is fabricated from a hardened, hollow cylindrical coupling blank. An outer surface of the coupling blank is coated with spray metal alloy, and the coated blank is heated to fuse the spray metal to the outer surface thereby forming a wear layer. This coating decrease brittleness of the wear layer, and limits cracking and subsequent stress riser effects on fatigue performance. The coupling blank is austenitized and liquid quenched to a specified hardness range. Fully cold formed threads are formed on an inner surface of the coupling blank. The fully cold formed threads maintain fatigue properties which are superior to fatigue properties obtained with partially cut, partially rolled threads on prior art high strength couplings. Fabrication methods are designed to be adaptable to current coupling manufacturing facilities, thereby minimizes modification and “start-up” costs required to manufacture the improved coupling.

### BACKGROUND OF THE INVENTION

1. Field of the Invention

This invention is directed toward couplings used to join sections of sucker rods to form a sucker rod string, and more particularly relates to couplings with optimum resistance to fatigue, hydrogen embrittlement, and corrosion encountered when used to join sections of sucker rods to form a sucker rod string for oil well applications.

2. Background of the Art

Fluids can be produced from oil and gas wells by utilizing internal pressure within a producing zone to lift the fluid through the well borehole to the surface of the earth. If internal formation pressure is insufficient, artificial fluid lift means and methods must be used to transfer fluids from the producing zone and through the borehole to the surface of the earth.

The most common artificial lift technology utilized in the domestic oil industry is the sucker rod pumping system. A sucker rod pumping system consists of a pumping unit that converts a rotary motion of a drive motor to a reciprocating motion of an artificial lift pump. The pump unit is connected to a polish rod and a group of connected sucker rods, commonly referred to as a “string”. The sucker rod string consists of individual sections of steel and/or fiberglass sucker rods in lengths of 25 or 30 feet (ft), and in diameters ranging from ⅝ inches (in.) to 1¼ in. These sucker rods have a threaded pin at each end, and are connected together with threaded couplings, often called boxes, to form the sucker rod string. The sucker rod pin and coupling box connection is tightened to a specified preload, also known as joint make-up, that prevents the connection from coming loose during normal operation. The sucker rod string transfers the reciprocating motion from a pumping unit at the surface of the earth to a rod pump positioned within the well borehole.

The rod pump typically consists of a plunger stroking within a closed tolerance barrel, similar to a piston and cylinder. The pump is valved in a manner that allows the intake of well fluids from the well bore, and subsequent lifting of those fluids around the sucker rod string inside a tube that extends up to the surface of the earth. A well head at the surface directs the fluids to a holding tank, and also contains a packing seal to prevent fluids from flowing out through the moving polish rod.

A sucker rod must not only support the loads generated by the pumping of the fluids, but must also support the weight of the other rods therebelow. Therefore, sucker rod load increases proportionate to the well depth and length of the sucker rod string within the well. In order to minimize over loading on the upper rods, smaller diameter rods are typically used further down the string. For example, a well may utilize 1″ diameter rod at the top, then step down to ⅞″ diameter rod at some point, and then to ¾″ diameter rod still further down. This is commonly referred to as “tapering”. Since the rod string must translate the reciprocating force during both stroking directions, the weight of the rods must be maintained in such a manner that the rod string remains in tension on both the upstroke and downstroke. If the weight of the upper rods exceeds the force required for pumping on the down stroke, the rod string can go into compression during the down stroke leading to bucking. To keep the rods straight and in tension, a large diameter rod, called a sinker bar, may be used. This large diameter rod is sufficiently heavy and stiff to resist bucking during the down stroke.

The American Petroleum Institute (API) has standardized the design, manufacture, and assembly of sucker rods and couplings. The API has three different grades of sucker rods and two grades of rod coupling that have specific loading limitations and operation guidelines. API uses the modified Goodman Stress diagram to determine the allowable range of stress for a sucker rod to attain satisfactory rod performance. As well depths have continually increased, the sucker rod strings may be loaded at or above the API recommended guideline. In addition, as wells get older, secondary recovery methods such as water flood, steam flood, carbon dioxide flood, etc. can result in increased corrosion potential. Greater corrosion potential coupled with higher loading requirement lead to higher sucker rod failure rates. Sucker rod string failures are very expensive and time consuming to repair because the string must first be disassembled and taken out of the well to access the failed rod. The failed rod is replaced, and the string is then replaced within the well. With increased loading and the resultant increase in sucker rod failures, oil producers have turned to high strength sucker rods in applications involving high load conditions as well as utilizing smaller diameter high strength rods to optimize production in shallower wells.

With the use of high strength rods in pumping systems, the convention has been to continue using regular API standard coupling, even though the couplings are being subjected to stresses exceeding API operating guidelines. Not much is known about the performance of couplings in high strength applications however, evidence indicates that a large portion of failures in rod pumping systems is pin failures mostly resulting from loss of preload. This loss of preload can be attributable to the lower strength levels of the standard API couplings when used with high strength rod.

Current high strength sucker rods have minimum yield strength of about 115,000 pounds per square inch (psi) and a minimum tensile of about 140,000 psi. In comparison, the API only specifies a minimum tensile of 90,000 psi on couplings. With this difference, it becomes evident that standard couplings may not be adequate for use in high strength sucker rod applications.

U.S. Pat. No. 5,334,268 teaches a method for producing high strength sucker rod couplings and that patent is incorporated herein by reference. A hollow cylindrical core is formed from a heat treatable steel. A thin coat of metallic alloy is applied to the outer surface of the core. The core is then heat treated. Threads are then partially cut into the inner surface of the core. Finally, the partially cut threads are cold worked to produce finished female threads to accept male threaded ends of sucker rod joints. Fatigue properties of couplings fabricated using this method are uncertain due to the method of partially cutting threads before cold forming, which yields reduced compressive residual stresses at the threads.

Other problems exist in prior art sucker rod couplings. These problems include coupling mechanical properties which are not compatible with sucker rod mechanical properties, and couplings that are too hard thereby sacrificing toughness for excess strength. In addition, higher hardness of some prior art couplings also makes the steel more susceptible to embrittlement and stress corrosion cracking. High hardness equates to higher notch sensitivities and potential for failure.

### SUMMARY OF THE INVENTION

The present invention includes an improved sucker rod coupling for use with high strength sucker rods, and methods for fabricating the coupling. The fabrication methods of the present invention are designed to be adaptable to current manufacturing processes. This minimizes modification and “start-up” expenses required to manufacture the improved coupling in a facility used for making prior art couplings. Coupling strength of the present invention is that required for use with high strength sucker rods rather than at extremely high strength levels. The present invention coupling exhibits improved toughness and improved resistance to hydrogen embrittlement in corrosive applications, when compared to prior art high strength couplings.

The coupling is fabricated from a hardenable, hollow cylindrical coupling blank. The outer surface of the coupling blank is coated with a spray metal alloy, and the coated blank is then reheated to fuse the spray metal to the outer surface thereby forming a wear layer. Spray metal is selected so that the hard surface layer is softer than wear layers used on prior art sucker rod couplings. This coating decreases brittleness of the hard surface layer, and limits cracking and subsequent stress riser effects on fatigue performance.

The coupling blank is then austenitized, fluid quenched, and tempered to a specified hardness range that assures strength levels comparable to those of the high strength sucker rod. The outer surface layer is finished by grinding, and final dimensions are obtained at the ends of the coupling by machining.

Fully cold formed threads are formed on the inner surface of the coupling blank. The fully cold formed threads maintain fatigue properties which are superior to fatigue properties obtained with partially cut, partially rolled threads on prior art high strength couplings. Additionally, the fully cold formed threads are formed in one step rather then two.

The finished coupling is coated with a material such as phosphate to minimize thread galling when the coupling accepts threaded joints of the mating sucker rod pin.

### BRIEF DESCRIPTION OF THE DRAWINGS

So that the manner in which the above recited features, advantages and objects the present invention are obtained and can be understood in detail, more particular description of the invention, briefly summarized above, may be had by reference to the embodiments thereof which are illustrated in the appended drawings.

FIG. 1 is a side sectional view illustrating a coupling embodied as a coupling typically used in assembling sucker rod strings.

### DETAILED DESCRIPTION OF THE PREFERRED EMBODIMENT

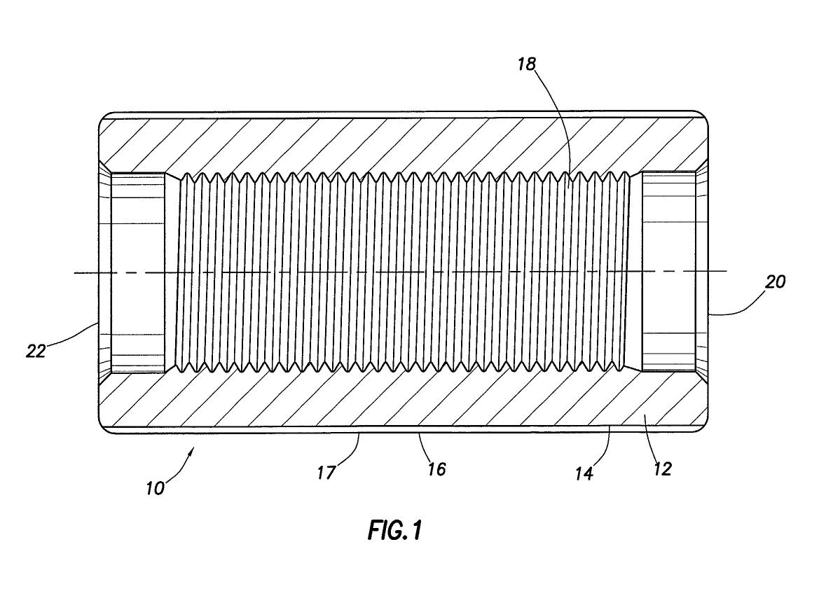

FIG. 1 is a side sectional view illustrating a coupling embodied as a coupling typically used in assembling sucker rod strings. The coupling 10 comprises a hollow alloy steel coupling blank 12 having an outer surface 14. The coupling blank 12 fabricated preferably from AISI 8630 or AISI 4130 hot rolled, extruded or cold drawn bar steel. Other steel that is capable of forming sucker rods may also be utilized. The outer surface 14 of the coupling blank 12 is rough grounded. The outer surface 14 is also preferably grit blasted to obtain surface anchor pattern for better adhesion of a protective wear coating 16. The protective coating 16 is fabricated by first spraying the outer surface 14 of the coupling blank 12 with 76-M-50-S or similar spray metal powder. The consistency of the powder is preferably within the mesh range of +115 to 325, and the powder is spray deposited using conventional spray deposition apparatus and methods known in the art. Coupling blank 12 is then reheated to fuse the spray metal to the outside surface 14 thereby forming a protective coating 16 which is at least 0.010 in. thick with a minimum Rockwell hardness (hereafter HRC) of 40.

The coupling blank 12 is austenitized at approximately 870 degrees centigrade (° C.) and then liquid quenched and tempered to a hardness range of 27 to 32 HRC. The quenching may be done with oil, water, polyquenched or other quenching techniques. A surface 17 of the coating layer 16 is ground finished to a surface finish not exceeding 63 μin Rₐ. The coating layer 16 provides an associated hard wear surface 17, which is softer than API and comparable to prior art spray metal. The deposition and fusing of the specified spray metal powder decreases brittleness of the hard coating surface layer 16 and limits cracking and subsequent stress riser effects on fatigue performance.

Still referring to FIG. 1, ends 20 and 22 of the coupling blank are machine finished to specified dimensions. Any chamfers, counter bores, or other features of the coupling are also machined into the coupling blank 12. Fully cold formed threads 18 are fabricated on an inner surface 24 of the coupling blank 12. Rolling is one method of cold forming threads. The fully cold formed threads 18 are fabricated by displacing metal in the coupling blank 12 using a cold form tap rather than by removing metal with a thread cutting process. Fully cold formed threads 18 maintain optimal fatigue properties when compared to the partially cut, partially rolled threads of prior art high strength couplings. Additionally, the fully formed threads are produced in one-step rather than two steps in the conventional methods. The finished coupling 10 is then coated preferably with phosphate (not shown) to prevent galling of the threads 18 with threads of sucker rod joints when the sucker rod string is assembled or “made up”.

To summarize, the sucker rod coupling apparatus and method of manufacture of the present invention exhibits advantages and improvements over prior art couplings. The coupling has fully cold formed threads and produced in one-step, rather than the partially cut, partially rolled threads of prior art high strength couplings. The fully cold formed threads maintain optimal fatigue properties of the coupling 10. Coupling strength is that required for use with high strength sucker rods rather than extremely high strength levels. This assures improved toughness and resistance to hydrogen embrittlement in corrosive applications compared to prior art high strength couplings. The fabrication methods detailed above can be implemented with basic apparatus used to fabricate prior art couplings. This reduces manufacturing costs in that a manufacturing facility need not be completely “retooled” to produce the improved sucker rod coupling 10.

While the foregoing is directed to the preferred embodiment of the present invention, other and further embodiments of the invention may be devised without departing from the basic scope thereof, and the scope thereof is determined by the claims that follow.

1. A sucker rod coupling comprising:
(a) a hollow, cylindrical coupling blank fabricated of hardenable metal;
(b) a wear layer on an outer surface of said coupling blank; and
(c) fully cold formed threads on an inner surface of said coupling blank.

2. The coupling of claim 1, wherein said fully cold formed threads are rolled threads.

3. The coupling of claim 1 wherein said wear layer comprises spray metal heat fused to said outer surface.

4. The coupling of claim 3 wherein said wear layer has a Rockwell hardness of at least 40 HRC.

5. The coupling of claim 3 wherein said wear layer is at least 0.010 inches thick.

6. The coupling of claim 1 wherein said coupling blank is liquid quenched and tempered to a Rockwell hardness of about 27 to 32 HRC.

7. The coupling of claim 3 wherein said wear layer has a surface finish not exceeding 63 μin Rₐ.

8. The coupling of claim 3 wherein said spray metal comprises 76-M-50-S or similar spray metal powder of about 115 to 325 mesh.

9. The coupling of claim 1 wherein said coupling blank comprises AISI 8630 or 4130 steel.

10. A method for fabricating a sucker rod coupling, comprising the steps of:
(a) forming a hollow, cylindrical coupling blank from hardenable metal;
(b) applying a wear layer on an outer surface of said coupling blank; and
(c) forming fully cold formed threads on an inner surface of said coupling blank.

11. The method of claim 10, wherein said fully cold formed threads are rolled threads.

12. The method of claim 10 further comprising:
(a) spraying said outer surface with a spray metal; and
(b) heating said coupling blank to fuse said spray metal to said outer surface thereby forming said wear layer with a Rockwell hardness of at least 40 HRC.

13. The method of claim 12 wherein said wear layer is at least 0.010 inches thick.

14. The method of claim 10 further including austenitizing said coupling blank at about 870° C. and then liquid quenching and tempering said coupling blank to a Rockwell hardness range of about 27 to 32 HRC.

15. The method of claim 12 including the additional step of rough grinding and grit blasting said outer surface prior to spraying said outer surface with said spray metal thereby obtaining improved spray metal adhesion to said outer surface.

16. The method of claim 10 including the additional step of finishing said wear layer to a surface finish not exceeding 63 μin Rₐ.

17. The method of claim 12 wherein said spray metal comprises 76-M-50-S or similar spray metal powder of about 115 to 325 mesh.

18. The method of claim 10 wherein said coupling blank comprises AISI 8630 or 4130 steel.

19. The method of claim 10 including the additional step of finishing coupling faces of said coupling by machining to specified dimensions.

20. The method of claim 10 comprising the additional step of coating said coupling with phosphate to minimizing thread galling.

21. A method for fabricating a sucker rod coupling, comprising the steps of:
(a) forming a hollow, cylindrical coupling blank fabricated of hardenable metal; and
(b) forming fully cold formed threads on an inner surface of said coupling blank.

22. The method of claim 21, wherein said fully cold formed threads are rolled threads.

23. The method of claim 21 comprising the additional steps of fabricating a wear layer on an outer surface of said coupling blank by:
(a) depositing a metallic powder on an outer surface of said coupling blank; and
(b) heating said coupling blank to fuse said metallic powder to said outer surface thereby forming said wear layer.
